(19) United States
(12) Patent Application Publication
(10) Pub. No.: US 2013/0158892 A1
(43) Pub. Date: Jun. 20, 2013

(54) METHOD FOR SELECTING A RESOURCE FROM A PLURALITY OF PROCESSING RESOURCES SO THAT THE PROBABLE TIMES TO FAILURE OF THE RESOURCES EVOLVE IN A SUBSTANTIALLY IDENTICAL MANNER

(71) Applicants: Olivier Heron, Bullion (FR); Julien Guilhemsang, Obernai (FR); Tushar Gupta, Marseille (FR); Nicolas Ventroux, Massy (FR)

(72) Inventors: Olivier Heron, Bullion (FR); Julien Guilhemsang, Obernai (FR); Tushar Gupta, Marseille (FR); Nicolas Ventroux, Massy (FR)

(21) Appl. No.: 13/520,551

(22) PCT Filed: Jan. 5, 2011
(86) PCT No.: PCT/EP11/50100

§ 371 Date: Feb. 10, 2013

(30) Foreign Application Priority Data
Jan. 5, 2010 (FR) 1000029

(51) Int. Cl. G06F 11/30

(52) U.S. Cl. CPC G06F 11/3055
USPC 702/34

(57) ABSTRACT

A method for selecting, from a plurality of processing resources capable in an information-processing system of carrying out one and the same type of process, one of the resources so that it carries out a process of said type, the method including estimating the probable time to failure for each of the resources, the resource being selected so that the probable times to failure of the resources evolve in a substantially identical manner.

### TECHNICAL FIELD

The present invention relates to a method for selecting, from a plurality of processing resources capable in an information-processing system of carrying out a given type of process, one of the resources so that it carries out a process of the given type, so that the probable times to failure of the resources evolve in a substantially identical manner. It applies notably in the field of the scheduling of tasks on multiprocessor onboard systems.

### PRIOR ART AND TECHNICAL PROBLEM

Many onboard systems today use dynamic processes requiring considerable computing powers and handling large quantities of data while ensuring a certain level of reliability. The reliability requirement is taking an increasingly important place whether it be in design or throughout the life cycle of the onboard devices. This is mainly due to the evolution of integration technologies which are making the devices on silicon increasingly sensitive to faults, affecting on the one hand the fabrication efficiency level and on the other hand the usage lifetime of the chips.

In parallel, the complexity of onboard applications is ceaselessly increasing, while the number of integrated applications grows constantly. This is explained notably by the desire to integrate ever more functionalities within the onboard systems by combining, for example in a mobile telephone, multimedia, telecommunication, positioning or else games functions. This may also be explained by the increase in the data volumes to be processed which are linked to the capacities of the video sensors, of the fast converters, etc.

Added to this increase in computing complexities is that of the dynamism of the processes. Specifically, the latter are tending to be adapted increasingly rapidly to their environment, depending on the context of use and on the data handled. It is therefore difficult to predict the behavior of an application or its execution time because the control flow and the handled data are complex. However, the behavior of the application has a strong influence on the ageing of the various hardware elements of the host system. Specifically, the activity of an element or its activation time has a direct influence on its life cycle and on the frequency of appearance of the first faults.

In the multiprocessor systems consisting of a plurality of computing resources, of storage resources and of interconnection networks, the scheduling of the tasks on the computing resources and the memory allocation are carried out dynamically during the execution of an application, without taking account of their impact on the ageing of the computing and storage resources. In the present application, a task is a sequence of instructions that can be executed by a computing resource without interruption, a scheduling algorithm making it possible to decide on the moment of execution of said sequence on said resource. Although the phenomenon of ageing of an integrated circuit is inevitable, this lack of consideration nevertheless results in accelerating the moment of appearance of a system failure during its use. Specifically, the use of a suboptimal scheduling technique in which a computing or storage resource is overused relative to the others—the activity of one resource having an influence on its ageing—may cause a fault to appear earlier in the life cycle of the resource, in the current as well as the future silicon fabrication technologies. The occurrence of a fault may cause a logic error which may result in a fatal failure of the system. This situation is unacceptable in the onboard field. This is one of the technical problems that the present invention proposes to solve.

The ageing of an integrated circuit (CI) is a slow and natural phenomenon of wear of the internal structures of the circuit over time, such as the wearing of the oxide of the MOS (Metal-Oxide-Semiconductor) transistors or the wearing of the metal lines, this wear being due notably to the conditions of use and of environment. At the minimum, this wear causes variation, reversibly or irreversibly, of electrical parameters in the MOS transistors, such as the threshold voltages or the switching frequencies. But this wear may go as far as causing irreversible damage to the structures, such as for example the creation of an absence of atoms in the via of a metal line.

The ageing of an CI depends on several factors, amongst which it is possible to cite for example:
the fabrication technology: the geometry of the structures, the materials used, the method of fabrication and of encapsulation used;
the quality of the production tests (for example burn-in);
the external environment of the CI: the temperature, the humidity, the radiations or else the human factor;
the design of the CI: the spatial arrangement of the components, the libraries used, the architecture used and its operating software programs, or else the available synthesis tools.

Controlling the ageing of CIs is the subject of intensive work. The various solutions currently proposed in the literature try to have an influence on one or more of these factors. For example, industrial solutions are aimed at improving the robustness of the fabrication technology and the quality of the production tests. But these approaches nevertheless require knowledge and full command of the fabrication method.

Other solutions are aimed at improving the design of the CI, in particular its architecture and its operating software programs. Specifically, since ageing depends on many electrical parameters such as the temperature, the switching frequency, the gate voltage of the transistors and others, a variation in one or more of these parameters may significantly affect the ageing of the CI. These parameters vary depending on the profile of the tasks executed on the system and on the operating mode of the resources in terms of voltage and of frequency.

A wide range of solutions indirectly addresses the ageing problem by trying to control its preponderant parameter, namely the junction temperature. Specifically, a linear variation in the junction temperature causes an exponential variation in the ageing of the structures of an CI. For most of the known mechanisms of ageing, the higher the junction temperature, the higher the likelihood of appearance of a fault at a given moment or the earlier the moment of structural failure. These heat-management solutions consist in preventing, in the computing resources:
i. the appearance of hot spots, that is to say of sites where the temperature is higher than a maximum safe limit, which on the one hand require the addition of costly mechanisms for cooling the module and which on the other hand accelerate the ageing of the hot structures;
ii. the accumulation over time of wide heat cycles which damage the module and the soldered elements of the CI;
iii. the extreme temperature gradients between the resources of the CI which may cause violation of the phase shift in the clock trees and a high thermomechanical stress between the structures.

The heat-management solutions can be divided into two categories depending on the adopted approach. The first category contains the reactive techniques of temperature control. The temperature of the resources is monitored during operation with the aid of integrated temperature sensors. When the temperature of the hot resources reaches the predefined heat threshold, a counterreaction is applied as a priority in order to stop the rise in temperature. For example, the clock frequency of the hot computing resource is reduced, or even temporarily disabled. One major drawback of this type of approach is that it penalizes performance. Another drawback is the absence of consideration for the temperature gradients and the wide thermal temporal cycles. These two phenomena have a significant influence on ageing. The second category contains the proactive control techniques, in which the control of the execution of the tasks is based on predicting or estimating the thermal profile of each computing resource. These solutions attempt to anticipate the future temperature profile of each resource so as to avoid any recourse to urgent counterreactions to the detriment of performance. On each clock wake-up, the scheduler uses the result of temperature estimation in order to decide on the tasks to be executed and on the computing resources to be used. Its algorithm ensures the best compromise between the temperature and performance requirements. These solutions differ from one another essentially in the scheduling algorithm and in the temperature-estimation model. Most of them also combine dynamic management of the voltage and the frequency of supply of the computing resources. Unfortunately these techniques only help very partially to minimize or to balance the ageing because they do not take account of all the parameters that affect the ageing of the computing resources; they consider only the temperature. Moreover, they do not explicitly address the problem of the ageing of the storage resources, because the temperature of the latter is much lower than that of the computing resources. Finally, reducing the temperature in order to slow ageing is undoubtedly not optimum when it is known that the activation of certain failure mechanisms is on the other hand accelerated when the temperature rises!

An article that appeared in 2008 entitled “Task Activity Vectors: A new metric for temperature-aware scheduling” (A. Merkel et al.) describes a heat-management solution using a task activity vector. This vector is used to guide the scheduling of the tasks so as to balance and minimize the temperature of a microprocessor or of a multiprocessor system. The size of the vector is equal to the number of functional units of the computing resources. One element of the vector represents the degree of use of the corresponding functional unit when a task is executed, between 0 (minimum) and 1 (maximum). The vector is supplied by various monitoring devices inserted into the processor, such as performance counters, or else by estimates of energy consumption originating from predictive models. The vector is updated periodically by the operating system in order to take account of the fact that the behavior of the task may change depending on the data to be processed. Here again, although not being limited to temperature, one of the major drawbacks of this solution is that it does not take account of all the parameters that affect the ageing of the computing resources. In particular, it does not take account of the changes in the environment external to the CI. Here again it is one of the technical problems that the present invention proposes to solve.

A patent entitled “System and Method for Analyzing Capacity in a Plurality of Processing Systems” (number U.S. Pat. No. 6,907,607 B1) proposes a solution for evaluating the usage over time (“capacity”) of a resource (processor, memory and network) and to adjust the workload between the resources so as to balance usage between them. However, the evaluation criterion is too abstract to allow a truly effective management of ageing. For example, the solution counts the load of a processor over a period of time but is not interested in the activity produced by this load in the processor. Ageing depends on the number of instructions, on the data read and written in memory and on the exceptions that have led to the execution of particular procedures. In the case of memories, the solution is interested only in the quantity of memory occupied for a period of time. But ageing of the memory also depends on the number of switchings generated by the reading or writing of the content. Moreover, this solution does not consider the other parameters that have an influence on ageing: voltage, frequency, surface area of the resources, internal/external temperature, external humidity.

A patent application entitled “Integrated Circuit Wearout Detection” (number US2008/0036487A1) proposes a solution for measuring the variations in time (due for example to ageing) on the paths of an integrated circuit and to apply corrective actions. However, the solution seems to incorporate its mechanisms on certain paths chosen in advance. The paths most affected by ageing, which are therefore representative of the ageing of the integrated circuit, depend on the usage made of the integrated circuit. Accordingly, the solution is not better than an approach based on the measured items of information: voltage, frequency, temperature and estimation of the activity of the integrated circuit or of the resource and external parameters (temperature and humidity). Moreover, the source of measured temperature is not specified. According to the analytical formulas manipulated by the solution, the measured temperature is the internal temperature of the circuit. This item of data is necessary but not sufficient.

A patent application entitled “Wear Leveling Techniques for FLASH EEPROM Systems” (number US2003/0227804A1) proposes a solution for counting the number of write and read operations in an EEPROM memory and for leveling the storage between the memory lines in order to mitigate their ageing. But first of all, this solution does not take account of the content of the data item that is written/read. Moreover, this solution cannot be applied unchanged to resources other than memories. Specifically, the only item of information on the number of access operations in a resource is not sufficient to be able to deduce pertinent ageing information.

A patent entitled “System and Method for Implementing Dynamic Lifetime Reliability Extension for Microprocessor Architectures” (number U.S. Pat. No. 7,386,851 B1) proposes a solution for estimating the lifetime of a pool of primary resources and for activating a secondary resource in order to replace a primary resource that has aged too far. However, the solution does not estimate the ageing of the secondary resources. Specifically, the secondary resources are used only for a period of idleness of the primary resource.

### SUMMARY OF THE INVENTION

The main object of the invention is to consider all the parameters that have an influence on ageing. In addition to temperature, it notably takes account explicitly of the internal switching activity of the resources with the aid, for example, of atomic counters which are devices making it possible to measure the switching activity in the resources and that operate according to principles similar to conventional performance counters. It also takes account of the current conditions in the external environment of the CI, with the aid of external sensors of temperature and even of humidity and with the aid of histories of activity in the adjacent resources. The invention is based notably on a test method making it possible to measure explicitly the temporal margin of the critical paths, that is to say the signal-propagation paths in the CI which are the most sensitive to ageing. These paths are not necessarily the critical paths of the resources, but may be paths chosen after a precharacterization of the behavior of the CI with respect to ageing, with the aid of simulation for example. The invention also uses a precharacterization of the probable time to failure of the resources that is induced by each task. This precharacterization may be obtained by simulation based on analytical ageing models, but it may also be obtained by experimentation with test vehicles fabricated on the target technology. Accordingly, the subject of the invention is a method for selecting, from a plurality of processing resources capable in an information-processing system of carrying out one and the same type of process, one of the resources so that it carries out a process of said type (i.e. a task) amongst a plurality of processes to be carried out (i.e. of the tasks to be executed). The method comprises a step of estimating a probable time to failure (or TTF) for each of the resources, this estimation step including using at least one macro-model of failures that makes it possible to estimate the probable time to failure of the resources, the resource being selected so that the probable times to failure of the resources evolve in a substantially identical manner while the processes are carried out.

In one embodiment, the macro-model may include a table which makes it possible to associate, with each resource and each process to be carried out, a value of probable time to failure of said resource, said table being filled prior to the use of the system by virtue of simulation tools. An arithmetic operation may be carried out on the failure in time (or FIT) of said resource and on the frequency of occurrence of a failure of said resource contained in the table, the failure in time of said resource being able to be the total value of the frequencies of occurrence of a failure of said resource that are contained in the table corresponding to the processes carried out previously by said resource.

Advantageously, the macro-model may also include measuring at least one parameter affecting the ageing of the resources, the failure in time of said resource being obtained by measuring at least one parameter affecting the ageing of said resource.

In one embodiment, the estimated time for each of the resources may be the probable time to failure that would result if the resource carried out the process.

In one embodiment, the selected resource may be that of which the probable estimated time to failure is the longest.

In a preferred embodiment, the measured parameter may be a parameter internal to the resources, such as the operating voltage and/or the operating frequency and/or the leakage current and/or the junction temperature and/or the time interval between the moment of switching of the output of a sensitive path and the moment of capture in the output register by the clock signal, from which the preloading time of said output register is deduced.

Advantageously, the internal parameter may also be measured by virtue of activity counters placed in each of the resources, each counter supplying an item of information on the current switching activity of the resource in which it is placed, a relation making it possible to deduce the variation in the temporal margin of the critical paths of said resource.

For example, the processing resources may be computing resources capable of executing tasks. These computing resources may be pipeline-architecture processors, each activity counter thus being able to supply the number of times that a pipeline stage is traversed or the number of instructions loaded or the number of read/write access operations on a register file or the number of loading/storage instructions executed or the number of switchings of bits on the inputs and the outputs in a pipeline stage.

For example, the processing resources may be storage resources capable of reserving memory spaces. Each activity counter may thus supply the number of read or write access operations on the storage resource or the number of access operations per memory bank or the number of access operations per memory line or the number of switchings of bits.

In another embodiment, the measured parameter may be a parameter external to the resources, such as the ambient temperature and/or the ambient humidity and/or the ambient radioactivity.

In a preferred embodiment, if a resource has a probable time to failure below a predetermined threshold, the power supply voltage and the clock frequency of said resource may be reduced or the tasks already allocated to said resource may be reallocated to other resources of which the probable times to failure are above the threshold or else said resource may be switched off.

### ADVANTAGES

Further main advantages of the invention are that it also takes account of the ageing of the storage resources. Moreover, the level of ageing of each resource is “stored” without having recourse to a nonvolatile memory, this being so despite the existence of a period when the power supply is switched off. Specifically, on each power-up, the current state of ageing is measured. This makes it possible to set the level of ageing of the resources at their real level, taking account of the phenomenon of regeneration of the transistors that took place during the last switch-off period. Moreover, this technique also makes it possible to take account of the impact on the ageing of the variability due to the fabrication method.

### DESCRIPTION OF THE FIGURES

Other features and advantages of the invention will appear with the aid of the following description made with respect to the appended drawings which represent:

FIGS. 1a, 1b and 1c, through diagrams, exemplary embodiments of the invention;

FIG. 1d, through a diagram, an example of a multiprocessor system consisting of a plurality of computing resources and of a plurality of storage resources;

FIG. 2, through a diagram, an example of architecture of a control resource according to the invention;

FIGS. 3a and 3b, through diagrams, examples of computing resources that can operate at different voltage-frequency combinations or that can be idled or electrically isolated according to the invention;

FIG. 4, through a diagram, an example of operation of a control unit according to the invention;

FIG. 5, through a diagram, an example of a module for estimating the ageing of the resources according to the invention.

The present application first of all proposes to explain the principles of the invention that make it possible to make a group of computing resources reliable by virtue of a centralized control. For example, the invention can be applied in the form of an extension of the function for controlling a group of processors. More precisely, the invention proposes to control the execution of the tasks on the computing resources and to place data of the data-page type and of the instruction type in shared SRAM (“Static Random Access Memory”) banks. The control proposed by the invention distributes the activity load imposed by the applications between the various elements of the architecture so as to level out their ageing.

The scheduling of the tasks is determined online and the affectment of the tasks to the computing resources obeys the following rule: after the loading of an application into the group of processors, the task controller selects the first task to be executed and allocates it to the free computing resource. A task is then allocated to a single computing resource. The allocation and the placement of the pages is determined online by the memory controller. The network of interconnections between the computing resources and the memory banks is designed so as to ensure an identical access time between a computing resource and any memory bank. When a choice between several placements is offered, the placement chosen is that which avoids the sharing of one memory bank between two or more computing resources. This is to prevent the addition of read/write wait cycles which are caused by collisions of access between several computing resources on one and the same bank.

The ageing over time of the materials of a chip, whether it be made of silicon, of metal or of oxide, results in the activation of damaging mechanisms that may cause a failure of the circuit. Amongst the main damaging mechanisms it is possible to cite, amongst others, the breakdown of oxide or “time-dependent dielectric breakdown” (TDDB), electromigration (EM), thermomechnical stress or “stress migration” (SM), “negative bias temperature instability” (NBTI) or “hot carrier injection” (HCl) or else wide fatigue thermal cycles or “thermal cycling” (TC). The TDDB, EM, SM and TC phenomena are destructive phenomena for the materials. They result first of all in the appearance of delays, called “dynamic variability”, causing violations of temporal margins on the paths that travel through the transistors affected by these phenomena. They may then cause the definitive loss of functionality. The NBTI and HCl phenomena, for their part, result essentially in the appearance of delays, these are also called “dynamic variability”, which may be intermittent and even reversible. Here again, the variability of the parameters may cause a logic error. This list of phenomena is not exhaustive and depends on the fabrication technology of the chip.

The invention proposes to control the execution of the tasks on the computing resources and the placement of pages in memory, whether they be data pages or instruction pages, by taking account of one or more criteria associated with the ageing of the elements. Amongst these criteria it is possible to cite, amongst others, the probable time to failure or TTF, the variation in the temporal margin of the critical paths for ageing or “Slack Time”, the temperature or else the total power consumed, whether it be static or dynamic. The invention notably proposes to select as an ageing criterion the TTF of each computing resource and of each memory bank which is a usual reliability metric. The TTF is expressed in hours. The reciprocal of the TTF is the FIT for “Failure In Time” which represents the frequency of occurrence of a failure and which is expressed as a number of errors for 10⁹ hours of operation. Although the invention a priori is aimed at leveling out the ageing between the resources, it may be easily adapted to other objectives. One alternative would notably be to accelerate the ageing of one element in particular and to associate it with error-detection mechanisms in order to detect the occurrence of the first failure.

A principle of the invention is to extrapolate at architectural level the failure phenomena described above in order to obtain macro-models of failures that make it possible to estimate approximately the TTF of the computing and storage resources. For this, each damaging mechanism can advantageously be analyzed in each resource, in order to extract the main parameters that can significantly affect the evolution of the mechanism in question. For example, the relationship between ageing and temperature is exponential. For the other parameters, a leading idea may be to obtain a relationship between their evolution and the switching activity in the resource, and variation in the temporal margin of the sensitive paths of the resource. After determination of this relationship, simple monitoring devices may advantageously be integrated into the architecture in order to measure online the value of the parameters. These monitoring devices may take different forms, such as for example:
several temperature sensors which can be inserted into the chip in order to measure the junction temperature of each element, or can be placed on the module, or else placed beside the CI in order to measure the ambient temperature;
one or more humidity and radioactivity sensors on the module of the CI, or even beside the module;
several means for counting the number of access operations on each computing resource and on each storage resource. Hereafter, these means can be called “atomic counters”. For a computing resource, this may typically involve counting the number of “fetch” cycles and “load/store” cycles or even to a finer degree, the number of access operations to the UAL (“Arithmetic Logic Unit”) or to the register file. For a storage resource, it may typically involve counting the number of read/write access operations for each bank or for each line. It may also involve counting the number of switchings on the inputs/outputs. Thus, a counter can be incremented when at least one switching occurs on the monitored inputs/outputs or on each input/output switching;
means for measuring the temporal margin of the paths that are most sensitive to ageing, for example by using the “parametric scan” technique described in patent application number EP2007060591. This technique makes it possible to evaluate the variation in the temporal margin of a path during a test phase without modifying the power supply voltage or the frequency. A device using this technique can be inserted at the output of any path and in particular those determined to be the most sensitive to ageing. Another measurement solution is proposed in patent application number US2008/0036487A1;
means for measuring the current consumed by a resource, the measurement being able for example to use the “Iddq” technique which makes it possible to measure the leakage current and its variation during a test phase.

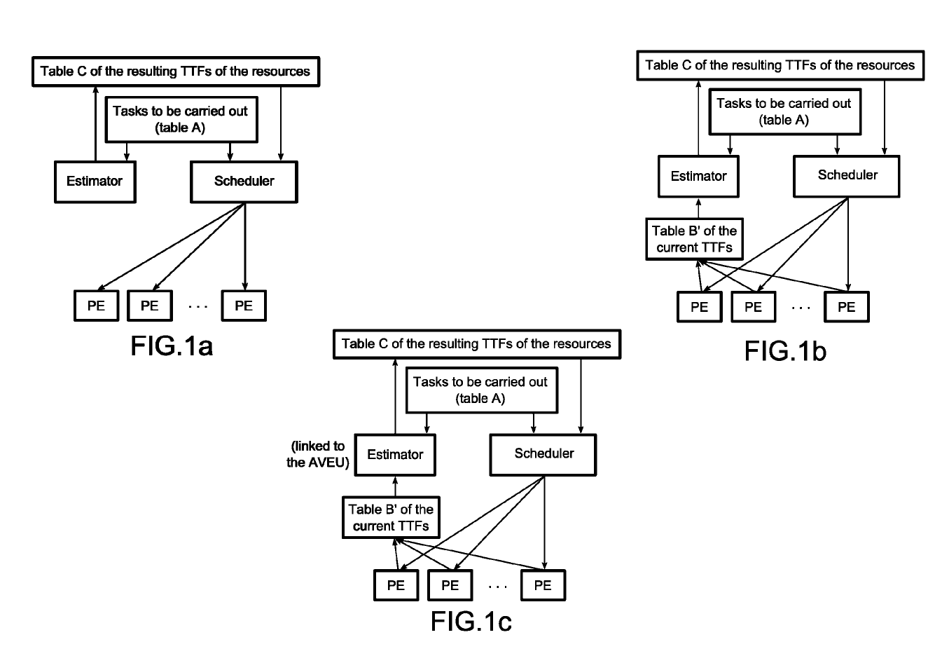

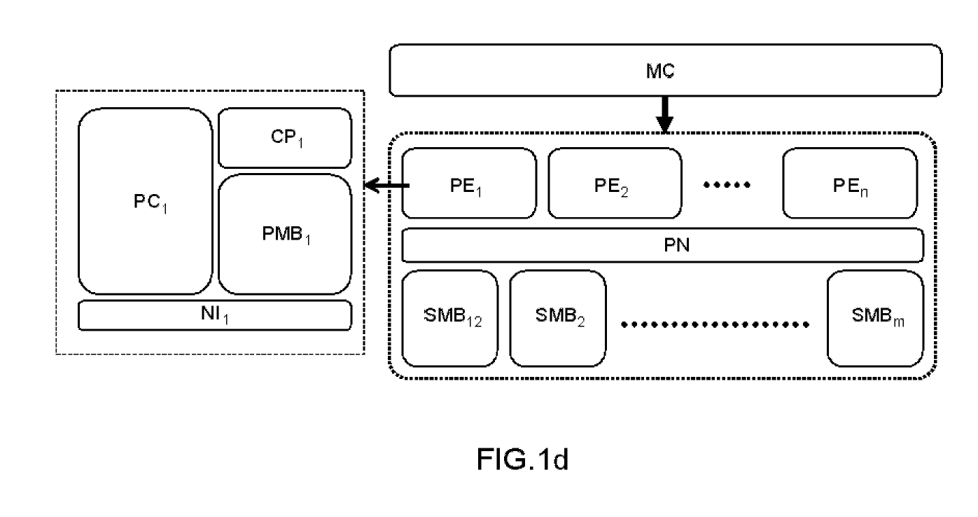

In a first embodiment illustrated by FIG. 1a, the affectment of tasks and the allocation of memory banks can be decided and carried out online based on TTF values of the resources evaluated offline. This then involves evaluating offline the TTF of each of the resources and for each of the associated failures, during the execution of the application, on the affectment of each of the tasks and on the allocation in memory of the various data items to be consumed or to be produced. This evaluation can be carried out for example with the aid of simulation tools. In this embodiment, no material monitoring device is necessary. The task and memory controllers can have a table (A) which lists, for each task to be carried out and for each data item to be allocated, the TTF (or the FIT) of the resources associated with their use. Moreover, these controllers can have another table (B) which contains the value of the current TTF of each resource. The current TTF of each resource is updated on each affectment or allocation step. The current value is then the reciprocal of the total of the FITs obtained during the previous affectments and allocations. These magnitudes can therefore be used for the online decision on the affectment of the tasks and on the allocation of the data. Before the effective affectment of a task, the task controller may have a table (C) which contains the TTF resulting from all of the computing resources for each task to be carried out. The resulting TTF of a resource is the reciprocal of the total of the current FIT of the resource (a value originating from the table (B)) and of the FIT of the resource associated with the task to be carried out (a value originating from the table (A)). It may therefore take the best decision to level out the resulting TTF of each of the computing resources. For example, it can select those of which the resulting TTFs are the longest. Similarly, the memory controller can estimate the resulting TTF of all of the memory banks and thus determine the optimal allocation, that is to say the allocation leading to an equitable or substantially identical ageing between the various memory banks.

In a variant of the first embodiment, it is also possible to decide offline on the affectment of all the tasks and the placement of all the data items in order to obtain an equitable or substantially identical ageing between all the resources. When the application is loaded into the circuit, the controllers can apply directly the affectment and allocation choices defined offline. The tables of TTF values are then not necessary. In order to be equivalent to the previous approach, this however assumes that all the resources have the same initial TTF on loading of the application (an assumption chosen offline).

In a second embodiment illustrated by FIG. 1b, the affectment of the tasks and the allocation of the memory banks can be carried out online based on information supplied online by material monitoring devices. Unlike the previous embodiment, no offline evaluation on the resources TTF associated with each task and with each item of data is given to the controllers (table (A) in this instance contains a constant neutral value). The selection of the tasks to be executed is therefore decided upon outside the context of the application. Each resource can have internal or nearby monitoring devices capable of measuring electrical or architectural parameters at any moment. The current values of the monitoring devices can then be used to deduce therefrom the current TTF of each resource. The estimation can be carried out regularly, at the moment of change of context in the architecture, for example. As above, the controllers can have a table (B′) (which replaces table (B)) containing the results of the estimation of the current TTF of each resource. The controllers also have a table (C) which stores the resulting TTF of each of the resources. As above, the resulting TTF is the reciprocal of the total of the FITs originating from the table (B′) and of the FIT originating from the table (A) (here containing a neutral value). On each update of the table (C), the task controller can modify the affectment of the current tasks so as to level out the ageing between all the computing resources. For example, after one or more consecutive evaluations, if, for one type of failure, the difference between the resulting TTFs of two computing resources being used exceeds a critical threshold, the affectment of the two respective tasks can be changed by migrating each one from its initial resource to the other resource. The critical thresholds can be determined depending on the technology used, on the fabrication method and on the design of the chip. Similarly, the memory controller can modify the allocation of the data so as to evenly distribute the ageing between all the banks.

A third embodiment illustrated by FIG. 1c can be a combination of the previous two embodiments. The controllers then have tables (A), (B′) and (C). The table (A) contains, for each task to be executed and for each item of data to be allocated, the TTF (or the FIT) of the resources associated with their use, obtained offline. The table (B′) contains the current TTF of each of the resources. The table (C) contains the resulting TTF of each resource and for each task to be carried out that is the reciprocal of the total of the FITs originating from the table (A) and of the FIT originating from the table (B′). The estimation of the current TTF of the element can be carried out depending on the technique described in the second embodiment above, that is to say with the aid of monitoring devices, while the affectment of the tasks and the allocation of the memory can be based on the principles described in the first embodiment. This approach has several advantages. In comparison with the first embodiment, it makes it possible to improve the accuracy on the resulting TTF of each resource. Specifically, the estimation of the FIT of a processor by totaling the FIT generated by the executed tasks, the FIT being computed offline, carries the risk of very probably diverging from the real FIT of the processor measured with the aid of monitoring hardware. Moreover, being able to estimate the real TTF of each element online makes it possible to take account of the dynamism of the tasks. Specifically, the execution of a task can take several different paths depending on the data processed and therefore generate a different ageing. Moreover, estimating the temperature may be difficult offline and it may be worthwhile to correct it during the execution. It should be noted that the online estimation has a role of closed-loop control for the task and memory controllers.

It should also be noted that the TTF of each computing resource can also take account of the local memories close to the processor, such as for example the data and instruction caches, the TLBs (Translation Lookaside Buffers) or else the “scratch” memories. It should also be understood that the three embodiments described above can be improved to take account of other criteria, such as the power consumed or the temporal margin of the critical paths. The decision on the execution of the tasks can then be the result of a combination between the various criteria.

FIG. 1d illustrates through a diagram an example of a multiprocessor system that may comprise n computing resources PE₁ to PEₙ (“Processing Element”) and m memory resources SMB₁ to SMBₘ (“Shared Memory Bank”) physically shared between the computing resources. Moreover, an interconnection network PN (“Programmable Network”) connects the computing resources to the storage resources. Finally, a central control resource MC (“Main Controller”) decides, selects, schedules and allocates the tasks on the computing resources. The main controller MC also makes it possible to load instructions and data and to dynamically allocate memory. It is therefore in the MC that the invention can be implemented. Each computing resource PEₖ (1≦k≦n) comprises a processor core PCₖ such as the core PC₁ illustrated in FIG. 1d in the form of a zoom on the resource PE₁. Each computing resource PEₖ (1≦k≦n) also comprises private memory banks PMBₖ and core peripherals CPₖ such as for example an interrupt controller, DMA controllers or else watchdogs. Each computing resource PEₖ (1≦k≦n) also comprises a network interface NIₖ.

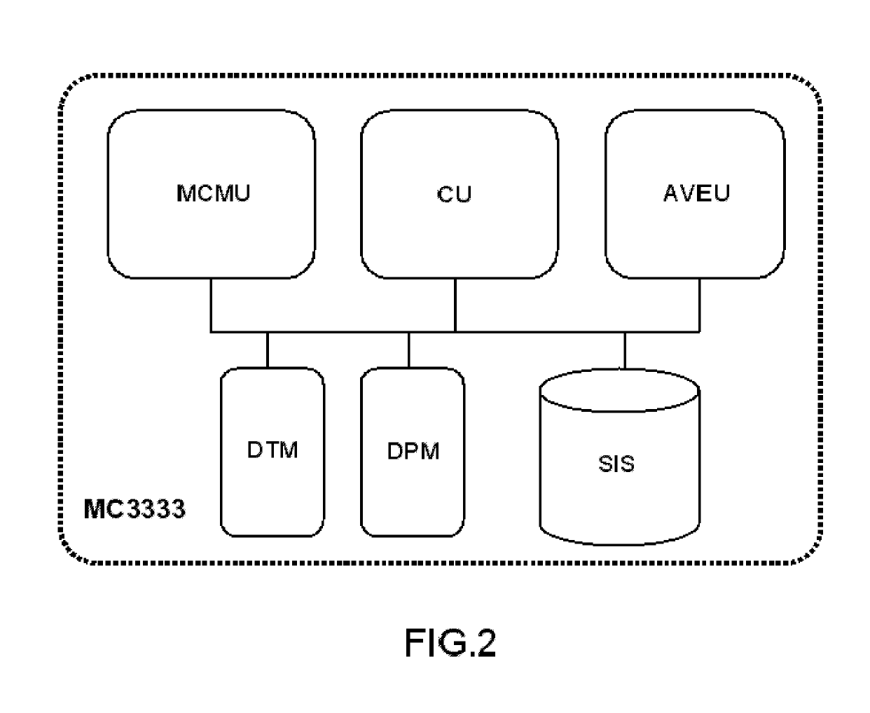

FIG. 2 illustrates through a diagram an example of an internal architecture of the main controller MC according to the invention. It consists mainly of a control unit CU making it possible to control the computing resources PE₁ to PEₙ, a memory configuration and management unit MCMU, an ageing/variability estimation unit AVEU and an SIS (system information storage) memory which contains the system information. Knowing the tasks that are being executed, the eligible tasks and the estimated ageing of the resources, under the performance constraints, the CU determines the best possible allocation on each new scheduling so as to minimize and even out the ageing (TTF), the temperature or the energy consumption, the various computing resources PE₁ to PEₙ and storage resources SMB₁ to SMBₘ. In a variant of the invention, the number of criteria may be reduced. The MCMU loads the instructions of the tasks to be executed from the outside memory to the shared memories. It also dynamically allocates memory for the data handled by the tasks. A DPM (“Dynamic Power Management”) unit is capable of activating various energy-consumption modes independently for each of the computing resources. It constantly informs the SIS memory on the energy-consumption mode of each of the resources. Each mode corresponds to a particular voltage-frequency pair which has the effect of controlling the energy consumption of the resource, its temperature, its activity rate and hence also its ageing. A DTM (“Dynamic Thermal Management”) unit is capable of urgently managing the problems of temperature of the resources. The DTM unit is capable, based on temperature sensors connected to the various resources, of notifying the SIS memory at all times on the temperature of the resources for which it is responsible.

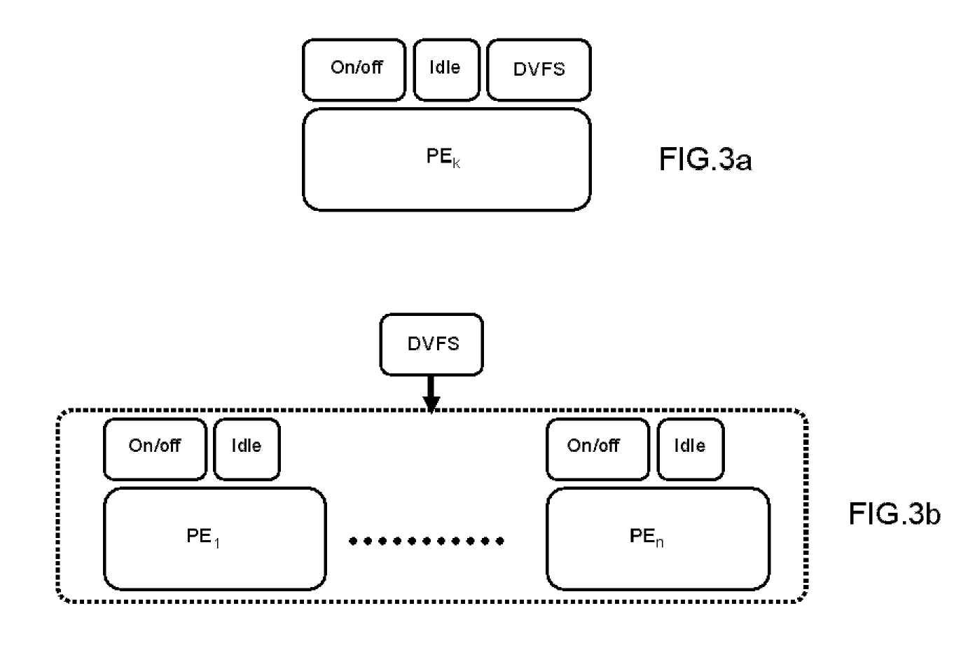

FIG. 3a illustrates through a diagram how any computing resource PEₖ (1≦k≦n) can operate at different voltage-frequency pairs or can be idled or can be electrically isolated (On/Off). FIG. 3b illustrates through a diagram how all the computing resources PE₁ to PEₙ can optionally operate simultaneously at different voltage-frequency pairs or can be idled or can be electrically isolated. For this, a DVFS (“Dynamic Voltage and Frequency Scaling”) unit controls the voltage and the frequency of the resource PEₖ, as illustrated by FIG. 3a, or of all the resources PE₁ to PEₙ, as illustrated by FIG. 3b.

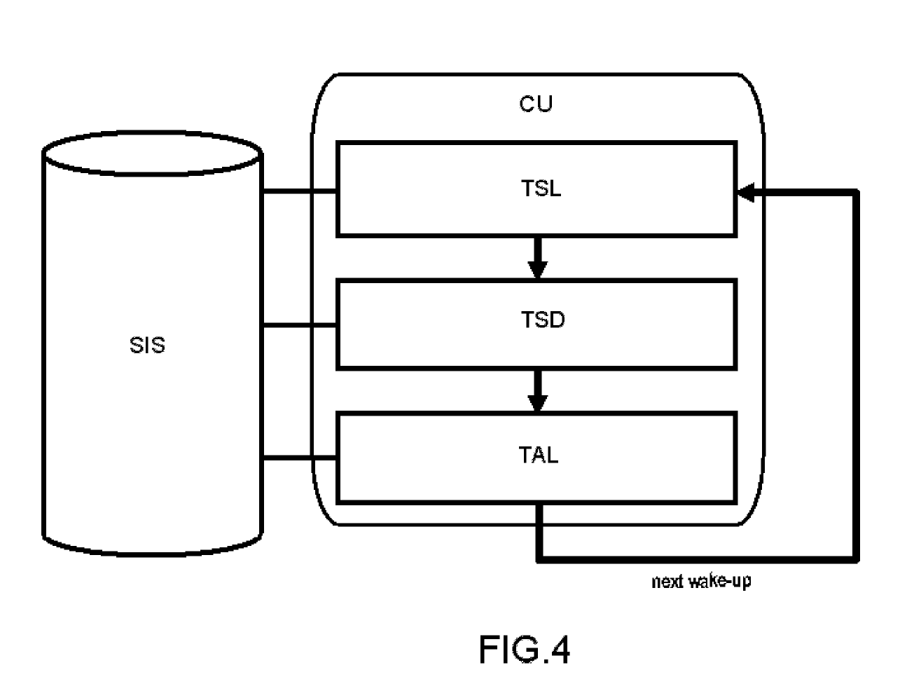

FIG. 4 illustrates through a diagram how, on clock wake-up and in relation with the SIS memory, the control unit CU chains in a loop a Task SeLection (TSL) phase, a Task ScheDuling (TSD) phase and a Task ALlocation (TAL) phase. Advantageously, the control unit CU can use a CDFG (“Control-Data Flow Graph”) which, for each application, describes all the dependencies of control and of data between the tasks. Specifically, the execution of each of the tasks is constrained by the execution of the previous tasks and a CDFG allows the CU to enable the new tasks in turn depending on the state of progress of the current tasks.

First of all, the CU schedules the tasks according to one or more characteristic magnitudes such as the time-out, the laxity, the induced temperature, the induced ageing or else the induced consumption.

Then, the CU determines, on each clock wake-up, all of the tasks ready to be executed. Each task is therefore scheduled according to an execution priority. The period between two wake-ups includes one or more clock cycles.

From this list of ready tasks, the CU selects p active tasks that are of highest priority, where p corresponds to the number of available resources (p≦n). The CU estimates, for each active task-resource pair, including the cold resources, the resulting TTF (TTFre—table C) based on the information obtained online by the AVEU and present in the SIS memory. The AVEU returns the estimate of the current TTF of each active resource (TTFra—table B′), for the current DVFS mode. The SIS memory contains the estimate of the TTF induced by each active task and for each DVFS mode obtained offline (TTFta—table A). When the active task is being executed, the estimate of the TTFre of each active task-active resource pair consists in computing the reciprocal of the total of the FITra (1/TTFra) and of the FITta (1/TTFta) for the current DVFS mode. When the active task is not yet executed, the estimate of the TTFre vector consists in taking the reciprocal of the total of the FITra (1/TTFra) and of the FITta (1/TTFta) corresponding to the “best” DVFS mode, that is to say the least aggressive mode offering maximum performance.

The CU then selects the best active task-active resource pairs that minimize the largest TTFre and level out the resulting ageing of the resources. It is also possible to envisage carrying out this selection according to several criteria, including therein for example the resulting temperature or the resulting energy consumption. If, despite the selection of the best pairs, the difference between the ageing of the computing resources is greater than the predefined threshold or the resulting ageing of a resource is greater than the predefined threshold, a mitigation strategy can be applied. If a DVFS mode that is more aggressive, that is to say with reduced voltage and/or frequency, exists and if the real-time constraints can always be obeyed, the latter is applied to the active resource that has the smallest TTFre corresponding to the greatest ageing. The CU then allocates the active tasks.

If no DVFS mode is available and if a cold resource is available, the CU enables the latter and the processor that has the smallest TTFre is switched off. The CU again searches for the best pairs including this new resource therein.

If no cold processor is available, the CU saves the context of the resource that has the smallest TTFre if the active task is being executed and switches off the resource. The resource can remain switched off definitively. But the resource may also remain switched off until it is sufficiently regenerated, on the next system power-up for example. It may also remain switched off until the TTFre of the other resources has reduced sufficiently. In order to decide whether or not the resource should be returned to service, the CU can advantageously use parametric test means included in the AVEU in order to obtain an estimate of the ageing of the isolated resource after it has been powered up. These parametric test means will be described in greater detail below. The CU then informs the system processor that it can no longer guarantee the real-time constraints. The CU finally deletes the active task of lowest priority from the list of pairs and carries out a new selection of the best pairs, considering the remaining tasks and the new list of active resources.

When the task-allocation process is finished, all of the tasks are allocated to the computing resources that are attributed to them. The active tasks being executed can be made to be preempted and then migrated to a new resource. During the execution of the tasks, the ageing of the resources used are updated by the AVEU in order to make it possible, on the next clock wake-up, to select new active task-active resource pairs.

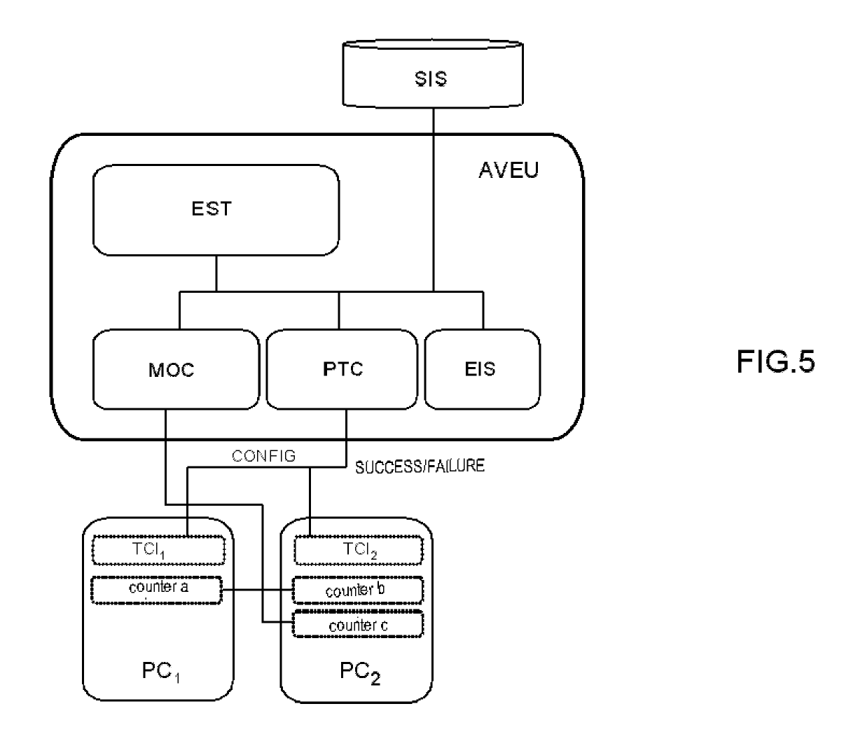

FIG. 5 illustrates through a diagram an example of the internal architecture of the AVEU according to the invention. Its role is to estimate the current ageing (TTFra) or the dynamic variability of each active resource of the system. Periodically, an estimation module EST reads and stores the values supplied by a monitoring controller MOC which can for example be connected to activity counters a, b and c inserted in the processor cores PC₁ and PC₂ respectively. The estimation module EST can also read and store the values supplied by the external sensors via an EIS (“External Sensor Interface”) interface. For example, this may involve values supplied by external temperature sensors and stored in the SIS memory by the DTM module. The external sensors can be situated around or on the module of the host chip, so as to measure the ambient temperature and humidity for example. In other embodiments of the invention, the EST unit may take account of other types of sensors such as for example the surrounding radioactivity. Then, the EST unit computes a vector TTFra[r] in which the input r represents the estimated value of the current TTF of the resource r. The estimate may be based on analytical equations or on LUTs (“Look-Up Tables”). The analytical equations may make it possible to determine the current TTF of the resource r as a function of electrical parameters such as, for example, the voltage, the frequency or the leakage current, and as a function of technological parameters such as for example the junction temperature or the ambient temperature. Moreover, the EST unit can be connected to the DPM unit and to the DTM unit in order to ascertain the operating mode of the resources, on or off, idle or not, operating voltage and frequency, etc.

Depending on the estimation method or depending on the failure models used, the monitoring devices can take various forms: current probes inserted in series on the power supply lines, temperature probes inserted on the CI, etc. In the present exemplary embodiment of the invention, two types of monitoring devices may be essentially used: the activity counters such as a, b and c, and temporal margin measurement devices as explained below. These temporal margin measurement devices can be used via interface units TCI₁ and TCI₂ (“Test Control Interface”) in PC₁ and PC₂ respectively; that is why the AVEU may advantageously comprise a parametric test controller PTC making it possible to obtain, by means of TCI₁ and TCI₂, an estimate of the ageing of the processor cores PC₁ and PC₂ respectively. It is possible to associate with this the period of use of each resource by the applications since the last power-up.

Advantageously, the activity counters a, b and c can be used to obtain an item of information on the current switching activity in the processor cores PC₁ and PC₂. In addition to the junction temperature, the other parameters of the failure models are intimately linked to the electrical stress of the structures. The activity counters a, b and c reflect the electrical stress in the processor cores PC₁ and PC₂. A resource may contain one or more counters, such as PC₂ in FIG. 5. For example, in a pipeline-architecture processor, these activity counters may for example indicate the number of times that a stage of the pipeline is traversed or the number of instructions fetched or the number of read/write access operations on the register file or the number of load/store operations carried out or else the number of operations carried out by the functional units. This list is nonlimiting and other monitoring devices may also count the number of bit switchings on the inputs and outputs in a stage of the pipeline.

In a storage resource, these monitoring devices can indicate for example the number of read/write access operations on a memory. In a manner similar to the computing resources, other counters can be inserted therein and count the number of access operations per memory bank or per memory link. Other monitoring devices may also count the number of bit switchings in the memory. In the interconnection resources, the counters can count the number of times that a communication channel is used by a communication between a computing resource and a storage resource. This description is not exhaustive and does not limit the scope of the invention, since the EST unit can take account of many types of monitoring devices. These counters may be associated with annotations inserted into the code of the tasks on compilation. These annotations make it possible to tell the MOC unit of the moment of resetting of the counters, and even the important moments of reading the counter values.

Advantageously, the measurement of the temporal margin of the paths of the resource can be carried out, for its part, on each power-up and make it possible to initialize the current TTF of each resource (TTFra). The counters can also be reset to zero on each power-up. In the present exemplary embodiment of the invention, the measurement can be advantageously taken with the aid of a parametric test. However, other measurement techniques can be used, such as that proposed in patent number US2008/0036487. The initial current TTF of a resource depends on two phenomena: the complete or partial regeneration of the failure mechanisms in the transistors and the static variability on leaving the foundry. These two phenomena affect the propagation times of the paths of the resources and therefore their temporal margin. The temporal margin is the time difference between the moment of switching of the path output and the moment of capture in the output register by the clock signal, minus the register preloading time. The estimation of the initial TTFra of each resource can be obtained with the aid of a conversion table associated with the resource. This table can take as an input the various value or values of temporal margin measured in the resource and give a corresponding TTFra. The conversion table and the choice of paths to be measured can be determined based on a simulation analysis. The table can be loaded into the SIS memory on startup of the system. The measured paths are not necessarily the critical paths of the resource, but rather the paths sensitive to the electrical and thermal stresses. As for the other estimated TTF values, the estimated value of the initial TTF is stored in the SIS memory.

In the present exemplary embodiment, a device for measuring temporal margin can be placed in the processor core PC₁. This same device can be inserted into the storage elements. It can be used by means of the interface unit TCI₁. It is the PTC unit that can advantageously take the measurement by parametric test on power-up. In the present exemplary embodiment of the invention, the parametric test may be that described in patent application number EP2007060591, which is based on a conventional BIST (“Built In Self Test”) technique. In this patent application, the design of the scan registers is modified so as to degrade the rising and falling transitions of the output signals. This artifice makes it possible to slow down the propagation time of the paths connected to the output of these modified registers. This modification is applied to a predefined subset of paths, hence of scan registers. A test control unit controls the application of the test and the configuration of the mode of degradation of the scan registers. First of all it controls the logical isolation of the circuit under test and then the activation of the test vector generator, the loading of the scan registers, the retrieval of the responses on the outputs and the downloading of the scan chains. Finally, it returns a SUCCESS or FAILURE result to the PTC unit. The latter controls the starting or stopping of the test: it sends configuration information CONFIG concerning the degradation mode and reads the SUCCESS or FAILURE result of the test. A measurement of temporal margin results in the determination of a degradation mode. If a SUCCESS result is obtained, it indicates to the estimator that the real temporal margin of the processor under test is greater than or equal to a benchmark. In the case of a FAILURE, it indicates thereto that the temporal margin is below the benchmark.

### OTHER ADVANTAGES

The invention described above therefore makes it possible to level out the ageing as much as possible between the various resources so as to delay the moment when failures appear. By intelligently distributing the tasks on the computing resources and the use of the storage resources according to the induced ageing, the invention makes it possible to substantially improve the reliability of multiprocessor architectures.

1. A method for selecting, from a plurality of processing resources capable in an information-processing system of carrying out one and the same type of process, one of the resources so that it carries out a process of said type amongst a plurality of processes to be carried out, the method comprising:
estimating a probable time to failure for each of the resources, the estimating including using at least one macro-model of failures that makes it possible to estimate the probable time to failure of the resources, the resource being selected so that the probable times to failure of the resources evolve in a substantially identical manner while the processes are carried out
wherein the macro-model includes a table that associates, with each resource and with each process to be carried out, a frequency of occurrence of a failure, said table being filled prior to the use of the system by virtue of simulation tools, the probable time to failure of each resource being estimated equal to the reciprocal of the sum, on the one hand, of the frequency of occurrence of a failure contained in the table which is associated with the resource and with the processing to be performed which are considered, and, on the other hand, of a current frequency of occurrence of a failure of the resource considered.

2. The method of claim 1, wherein the current frequency of occurrence of a failure of a resource is the total value of the frequencies of occurrence of a failure of said resource that are contained in the table corresponding to the processes carried out previously by said resource.

3. The method of claim 1, wherein the macro-model also includes measuring at least one parameter affecting the ageing of the resources, the current frequency of occurrence of a failure of said resource being obtained by measuring at least one parameter affecting the ageing of said resource.

4. The method of claim 1, wherein the estimated probable time to failure of the resources is a probable time to failure that would result if the resource carried out the process.

5. The method of claim 1, wherein the selected resource is that of which the estimated probable time to failure is the longest.

6. The method of claim 3, wherein the measured parameter is a parameter internal to the resources.

7. The method of claim 6, wherein the internal measured parameter is, for each of the resources:
an operating voltage, and/or;
an operating frequency, and/or;
a leakage current, and/or;
a junction temperature, and/or;
a time interval between a moment of switching of an output of a sensitive path and a moment of capture in an output register by a clock signal, from which a preloading time of said output register is deduced.

8. The method of claim 6, wherein the internal parameter is measured by virtue of activity counters placed in each of the resources, each counter supplying an item of information on the current switching activity of the resource in which it is placed, a relation making it possible to deduce the variation in the temporal margin of the critical paths of said resource.

9. The method of claim 1, wherein the processing resources are computing resources capable of executing tasks.

10. The method of claim 8, wherein each activity counter supplies:
a number of times that a pipeline stage is traversed, or
a number of instructions loaded, or
a number of read/write access operations on a register file, or
a number of loading/storage instructions executed, or
a number of switchings of bits on inputs and outputs in a pipeline stage.

11. The method of claim 1, wherein the processing resources are storage resources capable of reserving memory spaces.

12. The method of claim 8, wherein each activity counter supplies:
a number of read or write access operations on a storage resource, or
a number of access operations per memory bank, or
a number of access operations per memory line, or
a number of switchings of bits.

13. The method of claim 3, wherein the measured parameter is a parameter external to the resources.

14. The method of claim 13, wherein the measured external parameter is:
an ambient temperature, and/or;
an ambient humidity, and/or;
an ambient radioactivity.

15. The method of claim 1, wherein, if a resource has a probable time to failure below a predetermined threshold:
the power supply voltage and the clock frequency of said resource are reduced, or
tasks already allocated to said resource are reallocated to other resources of which the probable times to failure are above the threshold, or
said resource is switched off.

16. The method of claim 9, wherein each activity counter supplies:
a number of times that a pipeline stage is traversed, or
a number of instructions loaded, or
a number of read/write access operations on a register file, or
a number of loading/storage instructions executed, or
a number of switchings of bits on inputs and outputs in a pipeline stage.

17. The method of claim 11, wherein each activity counter supplies:
a number of read or write access operations on a storage resource, or
a number of access operations per memory bank, or
a number of access operations per memory line, or
a number of switchings of bits.
